(19) United States
(12) Patent Application Publication
(10) Pub. No.: US 2017/0145985 A1
(43) Pub. Date: May 25, 2017

(54) Hydrokinetic Turbine With Configurable Blades For Bi-Directional Rotation

(71) Applicant: Instream Energy Systems Corp., Vancouver (CA)

(72) Inventors: Peter Lyes, Bristol (GB); David Cocksedge, Bristol (GB)

(21) Appl. No.: 15/325,697

(22) PCT Filed: Aug. 11, 2014
(86) PCT No.: PCT/CA2014/050763

§ 371 Date: Jan. 11, 2017

Related U.S. Application Data
(60) Provisional application No. 62/023,731, filed on Jul. 11, 2014.

(51) Int. Cl. F03B 17/06

(52) U.S. Cl. CPC F03B 17/063; F05B 2210/404; F05B 2230/60; F05B 2240/24; F05B 2260/30; F05B 2220/32; F05B 2240/60

(57) ABSTRACT

A vertical axis hydrokinetic turbine apparatus comprises a drive shaft assembly, at least two blade assemblies, and at least two pairs of support arm connection interfaces. The drive shaft assembly comprises a rotatable drive shaft, an upper and lower center plates fixedly mounted to upper and lower ends of the drive shaft. Each blade assembly comprises a main blade having a longitudinally elongated body with a foil profile configured to produce lift in the presence of flowing water; and first and second support arms each having a longitudinally elongated body extending away from the main blade and terminating at a drive shaft connecting end. Each pair of support arm connection interfaces serve to releasably connect one of the blade assemblies to the drive shaft assembly and comprises upper and lower center plate components on the upper and lower center plates respectively, and support arm components on each of the first and second support arms. Each of upper and lower center plate components are configured to releasably connect to either of the support arm components, thereby enabling the blade assembly to be mounted to the drive shaft assembly in a clockwise rotation configuration wherein a leading edge of the main blade faces a clockwise rotation direction of the drive shaft, and in a counter-clockwise rotation configuration wherein the blade assembly is inverted 180° to the clockwise rotation configuration and wherein the leading edge of the main blade faces a counter-clockwise rotation direction of the drive shaft.

### FIELD

This invention relates generally to water turbines, and in particular to a hydrokinetic turbine apparatus with configurable blades that allow the turbine apparatus to rotate in a clockwise direction in one configuration and in a counter-clockwise direction in another configuration.

### BACKGROUND

Obtaining energy from renewable, non-fossil fuel sources has become increasingly important in recent years. Significant developments in wind and solar energy conversion technologies have resulted in wind and solar power becoming more mainstream and cost-effective energy sources. Wind and solar energy sources are however, inherently variable in output since the sun does not always shine nor does the wind always blow consistently throughout any given day or year.

In contrast, energy from free-flowing water in waterways such as rivers, canals, aqueducts, estuaries and tidal currents can be harvested by water, or hydrokinetic, turbines. While seasonal energy yields from free-flowing water many vary to some degree, daily or weekly output is relatively consistent and represents a stable, or firm source of baseload power.

While there are many variants of hydrokinetic turbine types including axial and cross-flow turbines, the vertical-axis cross-flow turbine employing lift generating blades has proven to be a robust platform for the extraction of energy from slow-moving waterways. Turbines can be supported in the waterway by spanning structures or by floating mounting structures (pontoons) and can be placed as either single devices or as an arrangement of multiple devices. It is often advantageous to deploy multiple turbines in a waterway for maximal energy extraction. It has been found that power extraction can be optimized by employing groups of turbines in certain locations that rotate in opposite directions; that is, some of the turbines are configured to rotate in a clockwise direction and other turbines are configured to rotate in a counter-clockwise direction. In addition, force loading on a floating structure with multiple turbines can also be effectively cancelled out by employing turbines with opposing rotational directions. This results in simpler and more cost-effective tethering systems.

It is desirable to provide a turbine that can readily reverse its rotational direction so that such turbines can be readily configured to rotate in either direction in the waterway; such readily configurable turbines could reduce capital and operating costs and improve operational efficiency.

Known recent developments in axial-flow vertical axis hydrokinetic turbines have been focused on increasing the efficiency of turbine output through blade and cross-arm drag reduction and by optimizing the angle of attack of the blades. These incremental developments do not allow for the turbine to readily change rotational direction. For example, U.S. Pat. No. 6,874,309 (Kazuichi Seki) describes the parametric constraints for a straight blade profile and its positioning to optimize efficiency and self-starting performance. Kazuichi Seki specifies specific geometric guidelines for blade angle, blade center solidity and blade thickness. The resulting turbine construction demonstrates a blade asymmetry with respect to an imaginary line radiating perpendicular from the axis of rotation extending to the vertical blade and is preferably made integrally with the blade support arms. Such a configuration dictates a prescribed rotational direction. Reversing the direction of the rotation cannot be readily achieved without a mirrored construction of the turbine blade and support arm structure incurring additional component and manufacturing costs.

### SUMMARY

According to one aspect of the invention, there is provided a vertical axis hydrokinetic turbine apparatus, comprising a draft shaft assembly, at least two blade assemblies, and a corresponding number of support arm connection interfaces for releasably connecting the blade assemblies to the drive shaft assembly. The drive shaft assembly comprises a rotatable drive shaft, an upper center plate fixedly mounted to an upper end of the drive shaft, and a lower center plate fixedly mounted to a lower end of the drive shaft. Each blade assembly comprises a main blade and first an second support arms. The main blade has a longitudinally elongated body with a foil profile configured to produce lift in the presence of flowing water. Each of the first and second support arms have a longitudinally elongated body extending away from the main blade and terminating at a drive shaft connecting end; a vertical spacing of the two draft shaft connecting ends corresponds to a vertical spacing of the upper and lower center plates. Each pair of support arm connection interfaces comprises an upper center plate component on the upper center plate, a lower center plate component on the lower center plate, and support arm components on each of the first and second support arms. Each of the upper and lower center plate components are configured to releasably connect to either of the support arm components, thereby enabling the blade assembly to be mounted to the drive shaft assembly in a clockwise rotation configuration wherein a leading edge of the main blade faces a clockwise rotation direction of the drive shaft, and in a counter-clockwise rotation configuration wherein the blade assembly is inverted 180° to the clockwise rotation configuration and wherein the leading edge of the main blade faces a counter-clockwise rotation direction of the drive shaft.

The first and second support arm components can comprise first and second male connectors respectively, and the upper and lower center plate components can comprise upper and lower female connectors respectively that are each configured to receive either of the first and second male connectors. More particularly, each of the first and second male connectors can protrude respectively from the first and second support arms at a location that is biased towards a leading edge of the first and second support arms corresponding to the leading edge of the main blade. In one instance, the upper and lower center plate components each further comprise a connecting arm extending radially outwards from the center plate and the upper and lower female connectors each comprise at least two bolt holes extending into the connecting arm and positioned symmetrically about a radial centerline of the connecting arm; the first and second male connectors each comprise at least one bolt protruding from the support arm to engage one of at the least two bolt holes when the blade assembly is in the clockwise rotation configuration, and to engage the other of the at least two bolt holes when the blade assembly is in the counter-clockwise rotation configuration.

Alternatively, the upper and lower center plate components can comprise upper and lower male connectors, and the first and second support arm components can be configured to receive either of the upper and lower male connectors.

In another instance, the upper and lower female connectors each comprise a cavity that extends radially into the respective upper and lower center plates, and the first and second male connectors each comprise a protrusion protruding longitudinally outwards from the drive shaft connecting end of the respective first and second support arms. In yet another instance, the upper and lower center plate components can each further comprise a connecting arm extending radially outwards from the respective upper or lower center plate and the upper and lower female connectors each comprise at least two holes extending into the connecting arm, and wherein the first and second male connectors each comprise at least one dowel protruding from the respective first or second support arm to engage one of the at least two holes, and at least one bolt protruding from the support arm to engage another of the at least two holes.

Alternatively, the first and second support arms and the main blade can have the same foil profile.

Each support arm can be connected at a blade connecting end to an inner surface of the main blade; each blade connecting end has a curvature that matches a curvature of the inner surface of the main blade such that the inner surface of the main blade mates flushly with the blade connecting ends. Alternatively, the blade can comprise first and second support arm connecting ends that connect respectively to an inner surface of the first and second support arms; each of the first and second support arm connecting ends has a curvature that respectively matches a curvature of the inner surface of the first and second support arms such that the inner surfaces of the first and second support arms mate flushly with the first and second support arm connecting ends.

Each blade assembly can comprise a first and a second corner joint, wherein each corner joint comprises at least one set of bores extending through the thickness of the main blade and into the blade connecting end of the first or second support arm, and a bolt for extending through each of the set of bores and connecting to the first or second support arm. Alternatively, each blade assembly can comprises a first and a second corner joint, wherein each corner joint comprises at least one protrusion extending from one of the blade connecting end and the inner surface of the main blade, and a cavity configured to receive the protrusion and located in the other of the blade connecting end and the inner surface of the main blade. Each corner joint can have a curved body with the first corner joint connected to the first support arm and one end of the main blade, and the second corner joint connected the second support arm and the other end of the main blade.

Each blade assembly, the support arms can be releasably coupled to the main blade, thereby allowing the apparatus to be compactly packaged in a kit form. Alternatively, the first and second support arms and main blade of each blade assembly can be integrally formed from a single component.

According to another aspect of the invention, there is provided a kit for a vertical axis hydrokinetic turbine apparatus, comprising a draft shaft assembly, at least two blade assemblies, and a corresponding number of support arm interfaces for releasably connecting the blade assemblies to the drive shaft assembly. The drive shaft assembly comprises a rotatable drive shaft, an upper center plate fixedly mountable to an upper end of the drive shaft, and a lower center plate fixedly mountable to a lower end of the drive shaft. Each blade assembly comprises a main blade and first and second support arms. The main blade has a longitudinally elongated body with a foil profile configured to produce lift in the presence of flowing water. The first and second support arms each have a longitudinally elongated body having a blade connecting end that is connectable to the main blade and an opposite drive shaft connecting end, wherein a vertical spacing of the two draft shaft connecting ends correspond to a vertical spacing of the upper and lower center plates when the blade assembly is assembled. Each pair of support arm connection interfaces comprise an upper center plate component on the upper center plate, a lower center plate component on the lower center plate, and support arm components on each of the first and second support arms. Each of upper and lower center plate components are configured to releasably connect to either of the support arm components, thereby enabling the blade assembly to be mounted to the drive shaft assembly in a clockwise rotation configuration wherein a leading edge of the main blade faces a clockwise rotation direction of the drive shaft, and in a counter-clockwise rotation configuration wherein the blade assembly is inverted 180° to the clockwise rotation configuration and wherein the leading edge of the main blade faces a counter-clockwise rotation direction of the drive shaft.

According to another aspect of the invention, there is provided a method for manufacturing a kit for a vertical axis hydrokinetic turbine apparatus, comprising: providing a rotatable drive shaft; providing an upper center plate fixedly connectable to an upper end of the drive shaft and a lower center plate fixedly connectable to a lower end of the drive shaft; providing a blade assembly source component, and providing at least two pairs of the aforementioned support arm connection interfaces. The blade assembly source component has a foil profile configured to produce lift in the presence of flowing water, and the method further comprises severing selected lengths of the blade assembly source component to form at least two first support arms, at least two second support arms and at least two main blades. At least two blade assemblies can be assembled by joining one of the first support arms and one of the second support arms to one of the blades to form each blade assembly.

### DESCRIPTION OF FIGURES

FIG. 1 is a perspective view of a hydrokinetic turbine apparatus with three blade assemblies that are configured for clockwise rotation and are invertible for counter-clockwise rotation, according to one embodiment of the invention.

FIG. 2 is a perspective detail view of a corner junction of one blade assembly, comprising an end of a main blade connected to an end of a support arm by a series of attachment bolts.

FIG. 3 is a exploded perspective detail view of the corner junction of the blade assembly shown in FIG. 2.

FIG. 4 is a foil profile of the main blade.

FIGS. 5(a) and 5(b) are top and bottom perspective detail views of a support arm connection interface of the hydrokinetic turbine apparatus, comprising a support arm bolt hole pattern, a center plate arm bolt hole pattern, and a plurality of attachment bolts that extend through bolt holes in the support arm and center plate arm bolt hole patterns to attach a support arm to a center plate.

FIG. 6 is a bottom perspective exploded detail view of parts of the center plate, support arm and attachment bolts.

FIG. 7(a) is a sectioned detail view of a first support arm of a blade assembly attached to an upper center plate arm such that the blade assembly is mounted in a clockwise rotation configuration that causes the turbine to rotate in a clockwise direction. FIG. 7(b) is a detailed section view of a second support arm of the blade assembly attached to the upper center plate arm such that the blade assembly is mounted in a counter clockwise rotation configuration that is inverted to the clockwise rotation configuration and which causes the turbine to rotate in a counter-clockwise direction.

FIG. 8 is a top view of the turbine apparatus wherein the blade assemblies are mounted in the clockwise rotation configuration and FIG. 9 is a top view of the turbine assembly wherein the blade assemblies are mounted in the counter-clockwise rotation configuration.

FIG. 9 is a top perspective detail view of an alternative embodiment of a blade assembly of the turbine apparatus.

FIGS. 10(a)-(c) are top perspective detail views of alternative embodiments of a blade assembly of the turbine apparatus, each featuring different corner junctions for connecting a support arm to a main blade.

FIG. 11(a) is a perspective view of an alternative embodiment of a blade assembly. FIG. 11(b) is a first embodiment of a corner junction for attaching a support arm to a main blade of this alternative embodiment of the blade assembly, and FIG. 11(c) is a second embodiment of a corner junction for attaching a support arm to a main blade of this alternative embodiment of the blade assembly.

FIGS. 12(a) and (b) are exploded and assembled top perspective views of a first alternative support arm connection interface for attaching support arms of different blade assemblies to a center plate of the turbine apparatus.

FIGS. 13(a) and (b) are exploded top and assembled bottom perspective views of a second alternative support arm connection interface for attaching a support arm of a blade assembly to a center plate of the turbine apparatus.

### DETAILED DESCRIPTION

Directional terms such as “upwards”, “downwards”, “horizontal”, “vertical” and “lateral” are used in the following description for the purpose of providing relative reference only, and are not intended to suggest any limitations on how any apparatus is to be positioned during use, or to be mounted in an assembly or relative to an environment.

Embodiments of the invention described herein relate generally to a vertical axis hydrokinetic turbine apparatus that comprises at least two pairs of detachable blade assemblies that are attached to a vertical drive shaft. Each blade assembly can be attached to the drive shaft in a clockwise rotation configuration which causes the turbine apparatus to rotate in a clockwise direction in the presence of flowing water. Each blade assembly can also be attached to the drive shaft in a counter-clockwise rotation configuration that is inverted 180° to the clockwise rotation configuration, and which causes the turbine apparatus to rotate in a counter-clockwise direction in the presence of flowing water. Each blade assembly comprises a lift generating vertical main blade and a pair of horizontal support arms (first and second support arms) extending laterally from each end of the main blade. The turbine apparatus also comprises a pair of center plates that are attached to the drive shaft (upper and lower center plates) and are vertically spaced from each other by a distance corresponding to the vertical spacing of the pair of support arms. In some embodiments each center plate comprises a plurality of connecting arms corresponding to the number of blade assemblies; each connecting arm of each center plate is provided with a support arm connection interface that can couple to either support arm in a blade assembly, thereby enabling each blade assembly to be mounted to the drive shaft in either the clockwise rotation configuration or the counter-clockwise rotation configuration, by simply inverting the blade assembly by 180°.

These embodiments of the hydrokinetic turbine apparatus are expected to provide a balance of performance and easy configurability with respect to the direction of rotation. This is particularly useful when multiple turbines are deployed in single row or a two-dimensional array in a waterway, as power extraction can be optimized by configuring some of the turbines to rotate in a clockwise direction, and some of the turbines to rotate in a counter-clockwise direction. Further, deploying turbines in opposing rotating directions can cancel out unwanted force loading on floating pontoons which support an array of turbines in the water way.

In addition to being easily configurable to rotate in the clockwise or counter-clockwise directions, the hydrokinetic turbine apparatus according to these embodiments can provide other advantages. For example, cost can be reduced because the same set of blade assemblies can be used for the turbine apparatus in both clockwise and counter-clockwise configurations, removing the necessity to provide separate blade assemblies for the turbine apparatus to rotate in each direction. Cost can also be reduced in certain embodiments where the support arms and the main blades have the same sectional profile; this allows the support arms and blades to be manufactured from the same components thereby reducing manufacturing complexity and costs. Manufacturing the support arms and main blades from the same component also has the advantage of being able to easily manufacture blade assemblies having different main blade lengths and different support arm lengths.

The hydrokinetic turbine apparatus can be provided as a kit of parts, wherein the parts are designed to be readily assembly and disassembled, as will be discussed in further detail below.

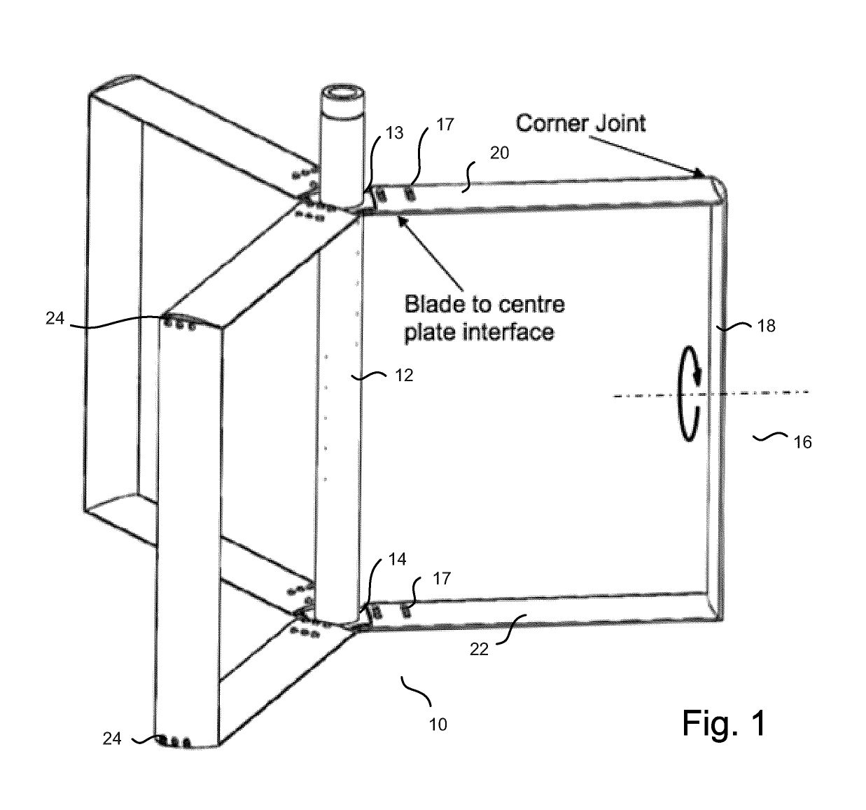

Referring now to FIGS. 1 to 8 and according to a first embodiment, a hydrokinetic turbine apparatus 10 generally comprises a vertical drive shaft 12 that can be rotationally mounted within a support frame (not shown) and coupled to an electrical generator (not shown) that converts rotation of the drive shaft 12 into electricity, in a manner that is well known in the art. An upper center plate 13 and a lower center plate 14 are fixedly mounted to upper and lower ends of the drive shaft 12, respectively. In this embodiment, each center plate 13, 14 is an attachment yolk that comprises three equidistantly spaced and radially extending connecting arms 15 which are aligned to form three pairs of blade assembly connecting arms which can detachably connect to three blade assemblies 16 by support arm connection interfaces 17. However, the turbine apparatus 10 can be provided with a different number of blade assemblies (e.g. two) in which case the number of pairs of center plate connecting arms 15 will be adjusted accordingly.

Each blade assembly 16 comprises a vertical main blade 18 and a pair of horizontal support arms, namely first and second horizontal support arms 20, 22 that are respectively attached by joint connectors 24 to each end of the blade 18 such that the support arms 20, 22 extend away from the main blade 18. While this embodiment features support arms 20, 22 that extend perpendicularly from the main blade 18, other embodiments can feature support arms that extend at different angles from the main blade 18.

As can be seen in FIG. 4, the main blade 18 has a longitudinally elongated body with a foil cross section that has a profile and an angle of attack that is designed to produce lift in the presence of flowing water. More particularly, the foil profile is defined by a chord length C, center distance X, angle of attack α and thickness at center T. In one embodiment, the angle of attack α is approximately 2.5°, a blade center distance to chord length ratio (X/C) is approximately 30%, a solidity ratio (N*C/R, wherein N is the number of blades and R is the radius from the blade center to the center of rotation) of approximately 0.53 and a blade center thickness T to chord length C ratio (T/C) of approximately 14.4%. The blade profile is symmetric about the blade's chord axis; as the main blade 18 is designed to be mounted vertically in the turbine apparatus 10, the part of the blade profile that faces the drive shaft 12 is herein referred to the foil inner surface and the part of the blade profile that faces away from the drive shaft 12 is herein referred to as the foil outer surface. In alternative embodiments, the main blade 18 can have different foil profiles, that also produce lift in the presence of flowing water.

In this embodiment, each support arm 20, 22 has a longitudinally elongated body with a cross-section having a foil profile that is the same as the main blade foil profile, wherein the support arms 20, 22 and main blade 18 are connected such that their leading edges are facing in the same direction. However, in other embodiments, the support arms 20, 22 can have a different cross sectional shape, e.g. have a different foil profile that still produces lift in the presence of flowing water, or have no foil profile at all. When the support arms 20, 22 have the same sectional profile as the blade 18, it is expected that manufacturing and/or operational cost can be reduced compared to using support arms and main blades with different cross-sectional profiles, since a common component can be used to form the support arms 20, 22 and the main blade 18.

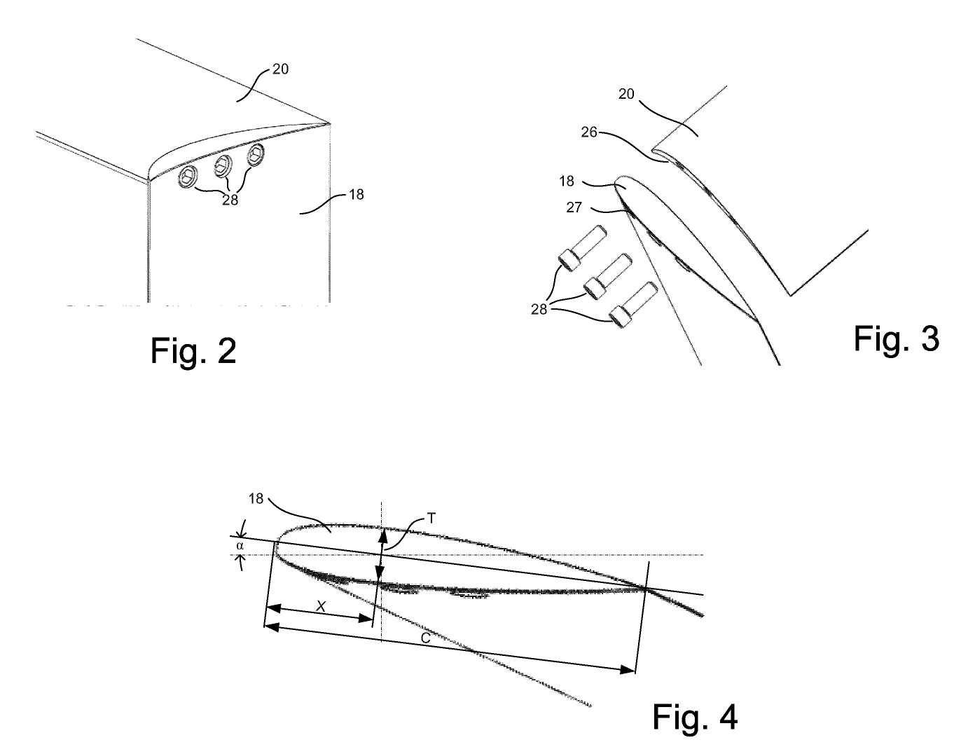

As can be seen particularly in FIGS. 2 and 3, the end of each support arm 20, 22 that connects to the main blade 18 (“blade connecting end”) is shaped to receive one of the ends of the vertical blade 18 such that the vertical blade 18 mates integrally and flushly with the support arms 20, 22 (“contoured blade connecting end”). More particularly, each contoured blade connecting end of the support arm 20, 22 has a curvature that matches the curvature of the foil inner surface of the main blade 18. Because the support arm blade connecting ends mate flushly with the ends of the main blade 18, a corner junction is provided with a seamless transition between the support arm 20, 22 and the main blade 18, and it is expected that there will be reduced drag forces and turbine blade end effects (e.g. wing tip vortex shedding or blade tip drag effect).

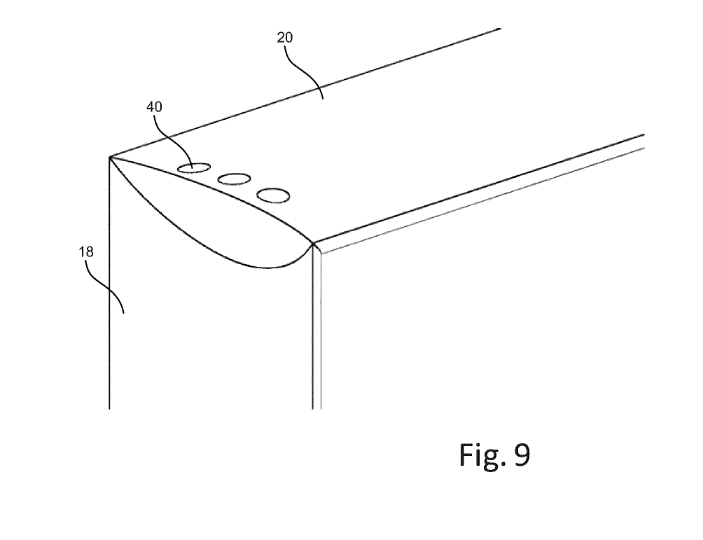

The joint connectors 24 that connect the main blade 18 to the support arms 20, 22 comprise threaded bolt holes 26 that extend inwardly into the blade connecting end of the support arms 20, 22, bolt holes 27 that extend through the thickness of the main blade 18 at each end thereof, and threaded joint bolts 28 that extend through the bolt holes 27 and thread into the threaded bolt holes 26 at each blade connecting end. Instead of threads, other means known in the art can be used to fix the bolts to the bolt holes. As will be described later with reference to FIGS. 9 to 11, other types of joint connectors 24 can also be used to secure the main blade 18 and support arms 20, 22 together.

Since the contoured blade connecting end of each support arm 20, 22 is asymmetrical, the main blade 18 can only be mounted in one specific orientation with respect to the support arms 20, 22; in other words, the main blade 18 cannot be inverted (rotated) 180° relative to the support arms 20, 22 in order to change the rotational direction of the blade assemblies 16. Therefore, the support arms 20, 22 are designed to detach from the center plates 13, 14 and the support arm connection interfaces are designed to attach to either support arm 20, 22, such that the entire blade assembly 16 can be inverted 180° and reattached to the center plates 13, 14 to change the rotational direction.

The end of the support arm 20, 22 opposite the blade connecting end is herein referred to as the drive shaft connecting end. A recess 37 is cut out of one major surface of each support arm 20, 22; the recess 37 has a generally rectangular shape and extends from the drive shaft connecting end of each support arm 20, 22 and inwardly along the length of the support arm 20, 22. The shape and size of the recess 37 are selected to correspond to the shape and size of one of the center plate connecting arms 15. In particular, the recess 37 can be configured to receive a center plate connecting arm 15 with minimal play, thereby ensuring a relatively secure connection between the drive shaft 12 and the blade assembly 16. The recess 37 also enables the center plate connecting arm 15 to mate relatively flushly with the support arm 20, 22 thereby providing a relatively low profile which is expected to minimize drag and flow disturbances.

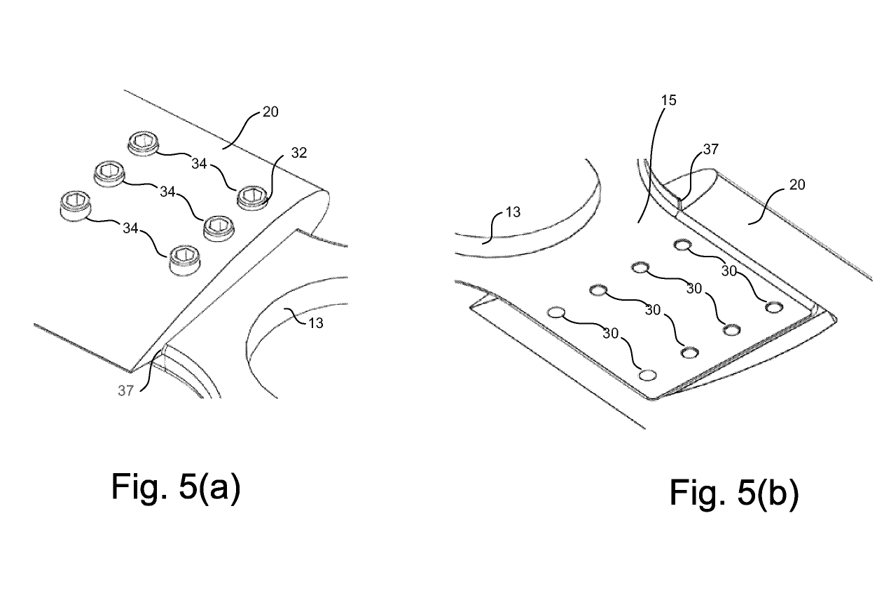

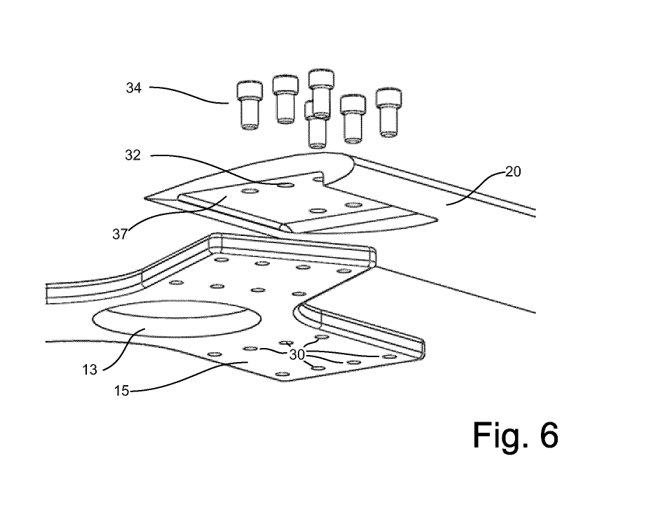

As can be seen in FIGS. 5(a), 5(b) and 6, the support arm connection interface 17 comprises threaded center plate bolt holes 30 that extend through the thickness of each center plate connecting arm 15, support arm bolt holes 32 that extend through the thickness of the support arms 20, 22 at the drive shaft connecting end, and threaded connecting bolts 34 that extend through the support arm bolt holes 32 and into some of the center plate bolt holes 30.

The center plate bolt holes 30 for each center plate connecting arm 15 are arranged in a bolt pattern that is distributed symmetrically about a radial centerline of the center plate connecting arm 15. In this embodiment, there are eight bolt holes 30 arranged in a 2×4 bolt pattern. However, other embodiments can feature a different number of bolt holes and/or a different bolt pattern.

The support arm bolt holes 32 for each support arm 20, 22 extend into the recess 37 and are arranged in a bolt pattern at a location that is biased towards the leading edge of the support arm 20, 22, i.e. the edge having the greatest thickness. This allows the bolts 34 to clamp the thicker portion of the support arm, maintain structural integrity, and allow counter-boring for the bolt heads as much as possible. In this embodiment, there are six bolt holes 32 arranged in a 2×3 pattern to receive six bolts 34. However, other embodiments can feature a different number of bolt holes and/or a different bolt pattern.

Because there are only six bolts 34 that extend through the six support arm bolt holes 32, only six of the eight bolt holes 30 of a center plate connecting arm 15 will be occupied when there is a connection. The particular center plate bolt holes 32 that will be occupied will depend on the rotational configuration of the blade assembly 16. In FIGS. 5(a) and (b), 6, 7(a) and 8(a) the first support arm 20 is shown attached to the upper center plate 13 in a clockwise rotational configuration, i.e. with the leading edge of the first support arm 20 facing the clockwise direction of the upper center plate 13. Here, the six bolts 34 will occupy the six center plate bolt holes 32 that align with the support arm bolt holes 30.

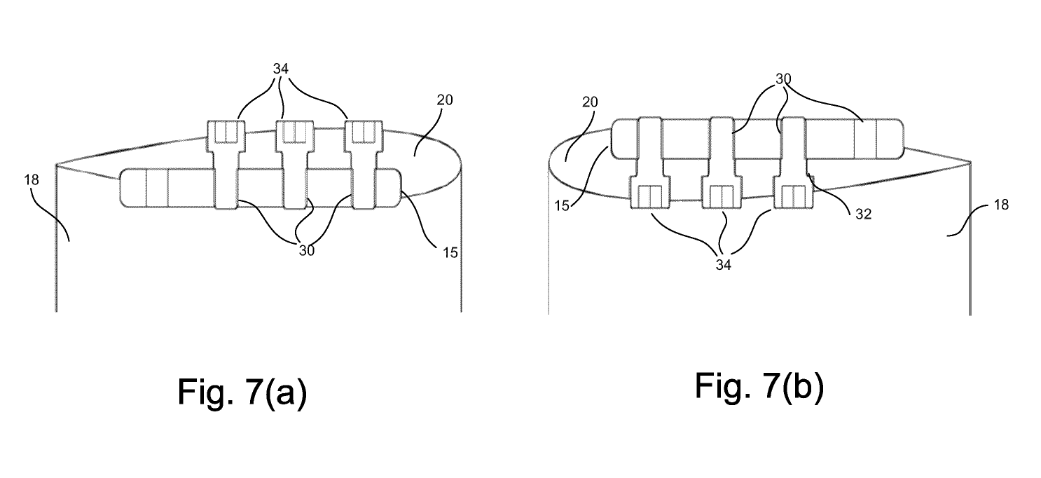

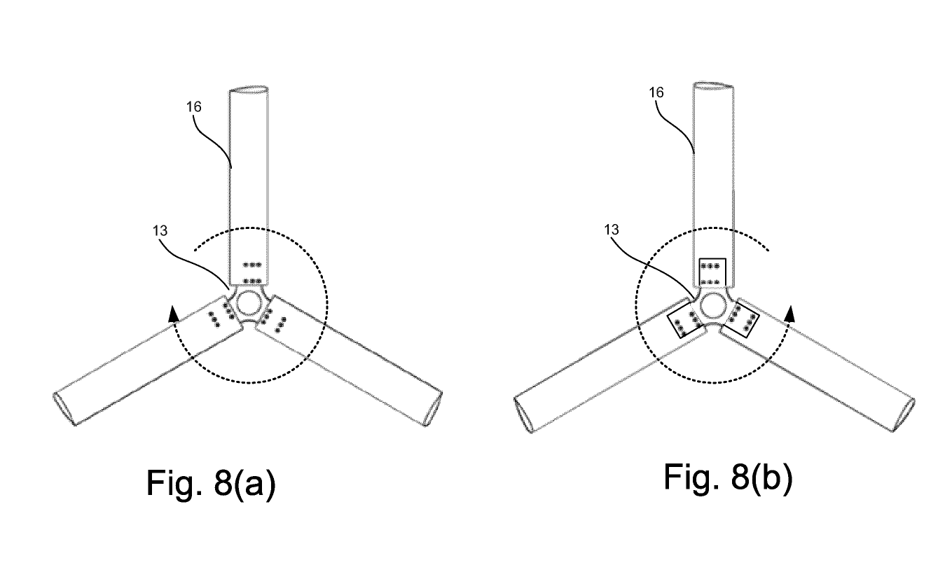

As can be seen in FIGS. 7(a) and (b), the symmetrical distribution of the center plate bolt holes 32 about the radial center line of the center plate connecting arm 15 enables each support arm 20, 22 to be attached to a corresponding center plate connecting arm 15 with its leading edge facing in one of two rotational directions (clockwise direction in FIG. 7(a), counter-clockwise direction in FIG. 7(b)). In the clockwise rotational configuration, the first support arm 20 of each blade assembly 16 is attached to the upper center plate 13 and the second support arm 20 of each blade assembly 16 is attached to the lower center plate 14. As can be seen in FIGS. 7(b) and 8(b), each blade assembly 16 can be reconfigured into the counter-clockwise rotational configuration by removing bolts 34, detaching the support arms 20, 22 from the corresponding center plate 13, 14, inverting the blade assembly 180° about the center normal axis, reattaching the blade assembly 16 to the center plates 13, 14 then reinserting the bolts 34 such that the leftmost six center plate bolt holes 32 are occupied. As a result, in the counter-clockwise rotational configuration the first support arm 20 is attached to the lower center plate 14 and the second support art 22 is attached to the upper center plate 13.

Because the center plate arm bolt pattern 32 is symmetrically distributed across the width of the center plate arm 15, each center plate connecting arm 15 can attach to either of the first and second support arms 20, 22; the only difference is that the recess 37 will be facing downwards when the blade assembly is in the clockwise rotation configuration (see FIG. 7(a)) and facing upwards when in the counter-clockwise rotation configuration (see FIG. 7(b)).

Because the support arms 20, 22 can be detached from the center plates 13, 14 by removing connecting bolts 34, and detached from the main blade 18 by removing joint bolts 28, the turbine apparatus 10 can be easily disassembled and reassembled. This enables the turbine apparatus 10 to be compactly packaged as a kit of parts. Since the corner joint design for that the first and second support arms 20, 22 are identical, the first and second support arms 20, 22 can be made identical, which simplifies assembly as well as manufacturing costs.

In addition to the first embodiment described above, there are other embodiments of the turbine apparatus that would be apparent to one skilled in the art. Alternative embodiments include different corner junctions to connect the support arms to the main blade, and different support arm connection interfaces for connecting the support arms to the drive shaft center plates.

Referring now to FIG. 9 and according to one alternative embodiment of a corner junction, the support arms 20, 22 extend over the main blade 18, and the main blade 18 is provided with contoured ends that are curved to match the curvature of the support arm surfaces that engage the main blade contoured ends. Bolt holes 40 extend through the thickness of each support arm 20, 22 and align with bolt holes (not shown) of the main blade 18 that extend inwards from each contoured end; bolts 42 can thus be used to bolt the support arms 20, 22 to the main blade 18 from above and below.

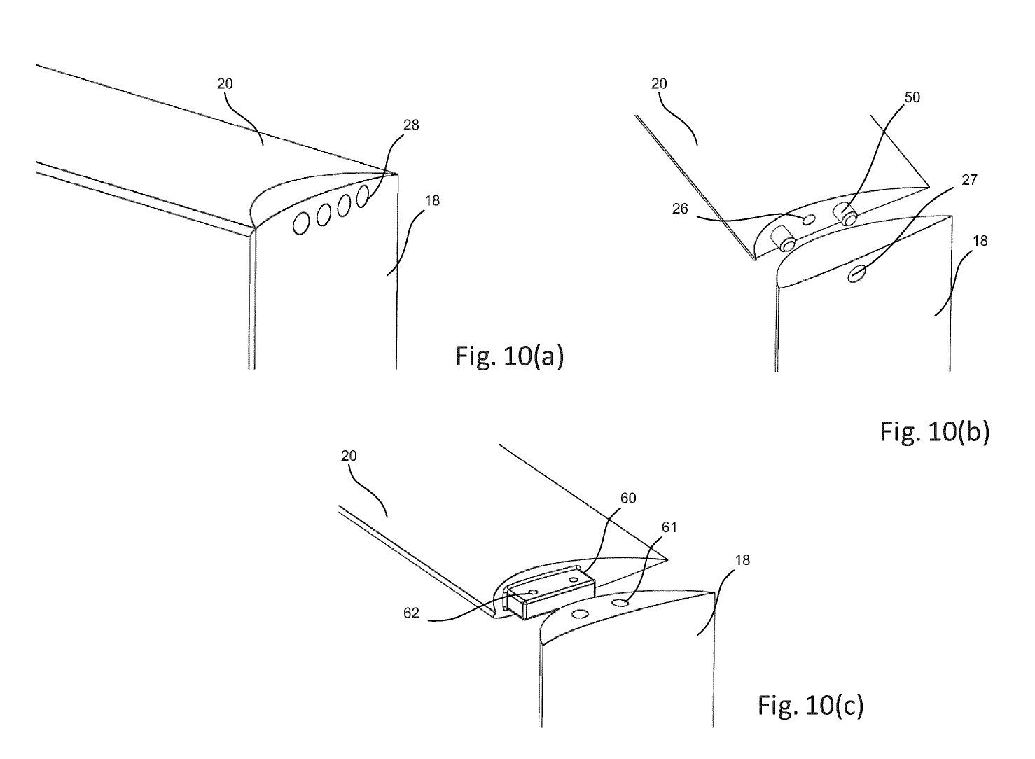

According to another alternative embodiment of a corner junction, the support arms 20, 22 are joined to the side of the main blade 18 in a similar manner as in the first embodiment, but feature a different number of bolt holes. For example, FIG. 10(a) shows a corner joint having four bolt holes with four joint bolts 28.

According to another alternative embodiment of a corner joint, one or more of the joint bolts 28 in the first embodiment is replaced by protrusions in the form of dowel pins. For example, FIG. 10(b) shows two dowel pins 50 protruding from a contoured connecting end of the support arm 20; threaded bolt hole 26 in the support arm 20 and bolt hole in the main blade 18 are aligned and serve to receive a threaded joint bolt (not shown), that secures the main blade 18 to the support arm 20.

According to another alternative embodiment of a corner joint, the support arm connecting end is provided with a protrusion and the main blade 18 is provided with a cavity that receives the protrusion; the protrusion can be secured inside the cavity using bolts, pins, a rotatable cam arrangement, and other latching means as is known in the art. For example, FIG. 10(c) shows a rectangular protrusion 60 that protrudes from a connecting end of the support arm 20 and engages a like shaped cavity (not shown) in the main blade 18. Openings 61 at the top of the main blade align with openings 62 at the top of the protrusion 60, which allow a bolt or pin (not shown) to secure the protrusion 60 to the cavity.

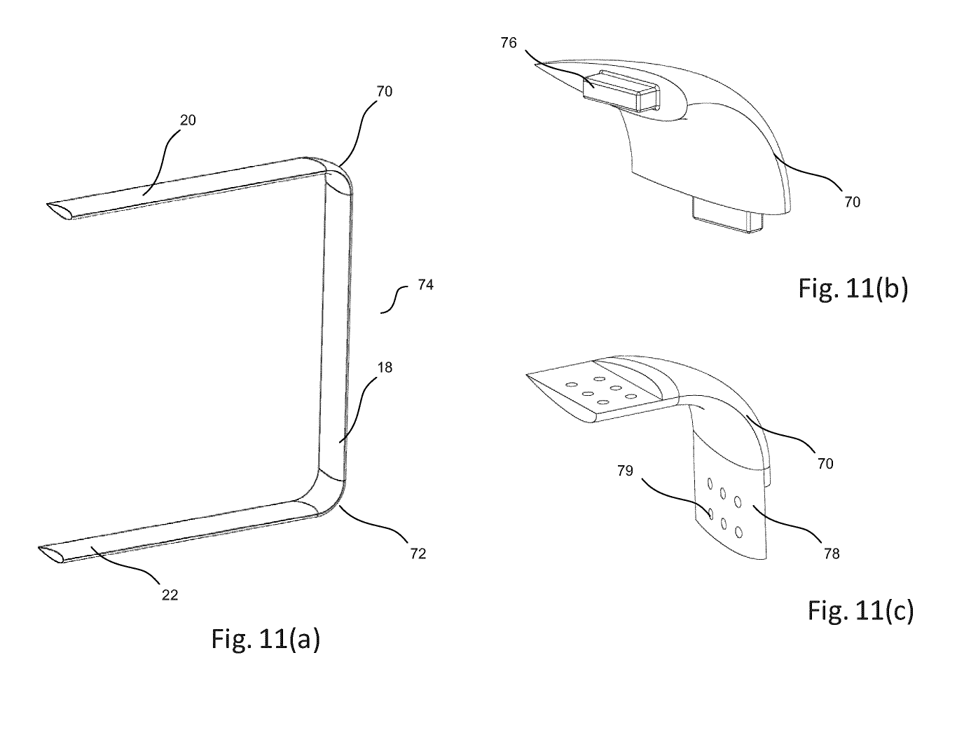

According to another embodiment of a corner joint, first and second curved corner junctions 70, 72 are provided which connect to the support arms 20, 22 and the main blade 18 to form a blade assembly 74 as shown in FIG. 11(a). As shown in FIG. 11(b), the corner junctions 70, 72 are provided with a 90° curved body and with protrusions 76 which engage mating cavities (not shown) in the support arms 20, 22 and main blade 18 in a similar manner as the embodiment shown in FIG. 10(c). As shown in FIG. 11(c), the corner junctions 70, 72 can instead be provided with a “lap” joint 78 with bolt holes 79 that align with bolt holes in the support arms 20, 22 and main blade 18 to receive joint bolts (not shown).

According to another alternative embodiment of a blade assembly (not shown), each blade assembly 18 is formed from a single component. For example, a single extruded component having a suitable foil profile can be bent twice to form a blade assembly comprising a main blade and two laterally extending support arms.

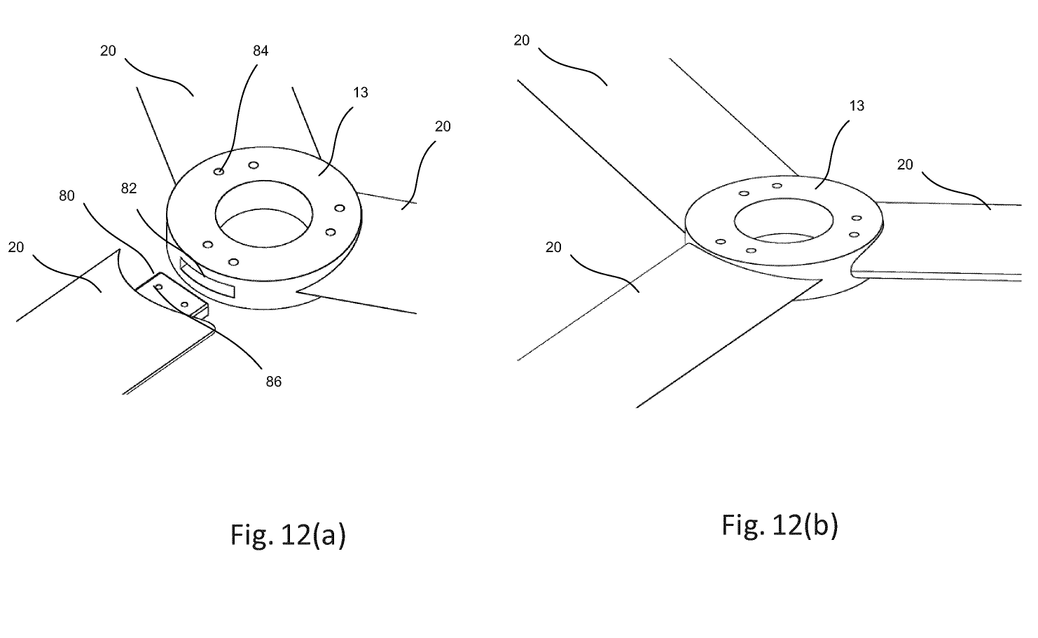

According to another alternative embodiment of a support arm connection interface, the center plates do not feature protruding connecting arms, and instead comprise a plurality of cavities, wherein each cavity is configured to receive a protrusion that protrudes from the drive shaft connecting end of a support arm. Alternatively, the protrusions can protrude from the center plate and engage cavities in the drive shaft connecting ends of the support arms. The protrusion can be secured inside the cavity using bolts, pins, a rotatable cam arrangement, and other latching means as is known in the art. For example, FIGS. 12(a) and (b) show three support arms 20 from three different blade assemblies, each support arm 20 having a protrusion 80 protruding from the drive shaft connecting end, and that engages a corresponding cavity 82 in the center plate 13. Openings 84 at the top of the center plate 13 align with openings 86 at the top of the protrusion 80, which allow a bolt or pin (not shown) to secure the protrusion 80 to the cavity 82. The protrusion 82 is biased towards the leading edge of the support arm 20 for the same reasons as described in the first embodiment. As shown in FIGS. 12(a) and (b), the support arms 20 are attached to the center plate 13 such that the blade assemblies are configured in a clockwise rotational configuration. Like the first embodiment, the support arms 20 can be detached, inverted 180° and reattached to the center plate 13 such that the blade assemblies are configured in the counter-clockwise rotational configuration.

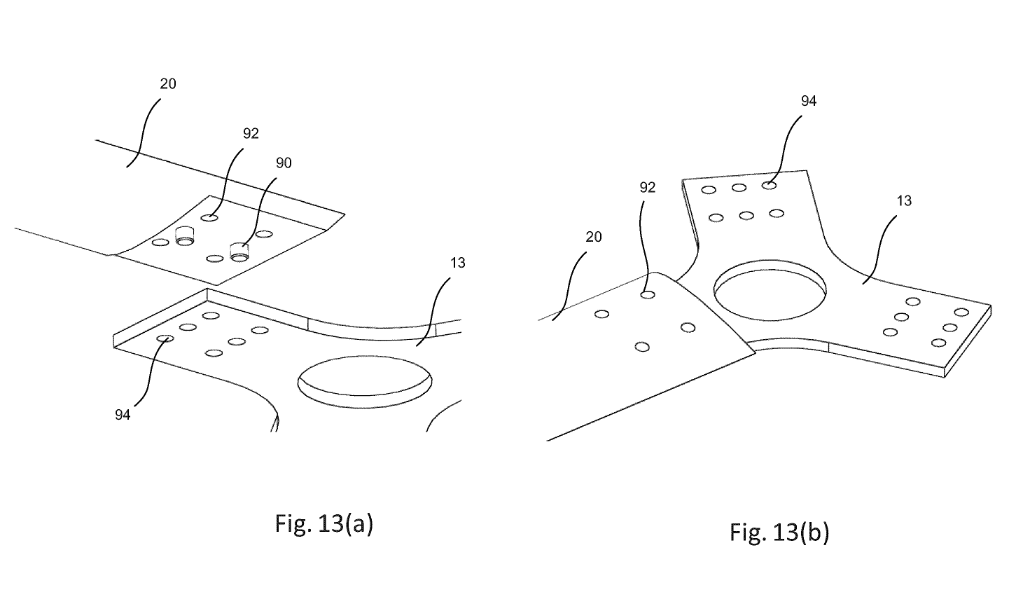

According to another alternative embodiment of a support arm connection interface, the recess in the support arms are replaced by a lap joint, and some of the bolt holes and bolts are replaced by dowel pins. For example, FIGS. 13(a) and (b) show a support arm 20 having a lap joint instead of a recess and comprises a pair of dowel pins 90 that protrude downwards from a longitudinal centerline of the lap joint. The dowel pins 90 engage a pair of center bolt holes in a group of center plate bolt holes 94 in a connecting arm of a center plate 13. Bolt holes 92 in the support arm lap joint align with the rest of the center plate bolt holes 94 when the dowel pins are engaged; bolts (not shown) can be inserted into the bolt holes 92, 94 to secure the support arm 20 to the top of the center plate 13. As shown in FIGS. 13(a) and (b), the support arm 20 is attached to the center plate 13 such that the associated blade assembly is configured in a clockwise rotational configuration. Like the first embodiment, the support arm 20 can be detached, inverted 180° and reattached to the bottom of the center plate 13 such that the blade assembly is configured in the counter-clockwise rotational configuration.

The scope of the claims should not be limited by the preferred embodiments set forth in the examples, but should be given the broadest interpretation consistent with the description as a whole.

1. A vertical axis hydrokinetic turbine apparatus, comprising:
a drive shaft assembly comprising a rotatable drive shaft, an upper center plate fixedly mounted to an upper end of the drive shaft, and a lower center plate fixedly mounted to a lower end of the drive shaft;
at least two blade assemblies, each blade assembly comprising:
a main blade having a longitudinally elongated body with a foil profile configured to produce lift in the presence of flowing water; and
first and second support arms each having a longitudinally elongated body extending away from the main blade and terminating at a drive shaft connecting end, wherein a vertical spacing of the two draft shaft connecting ends correspond to a vertical spacing of the upper and lower center plates, wherein the first and second support arms have the same foil profile as the main blade; and
at least two pairs of support arm connection interfaces, each pair for releasably connecting one of the blade assemblies to the drive shaft assembly and comprising an upper center plate component on the upper center plate comprising upper female connectors, a lower center plate component on the lower center plate comprising lower female connectors, and support arm components on each of the first and second support arms comprising a first support arm component having one or more first male connectors all collectively protruding from the first support arm at a location biased toward a leading edge of the first support arm, and a second support arm component having one or more second male connectors all collectively protruding from the second support arm at a location biased toward a leading edge of the second support arm, wherein each of the upper and lower female connectors of the upper and lower center plate components are configured to releasably connect to either of the first and second male connectors of the first and second support arm components, thereby enabling the blade assembly to be mounted to the drive shaft assembly in a clockwise rotation configuration wherein a leading edge of the main blade faces a clockwise rotation direction of the drive shaft, and in a counter-clockwise rotation configuration wherein the blade assembly is inverted 180° to the clockwise rotation configuration and wherein the leading edge of the main blade faces a counter-clockwise rotation direction of the drive shaft.

2.-3. (canceled)

4. The apparatus as claimed in claim 1, wherein the upper and lower center plate components each further comprise a connecting arm extending radially outwards from the center plate and the upper and lower female connectors each comprise at least two bolt holes extending into the connecting arm and positioned symmetrically about a radial centerline of the connecting arm, and wherein the first and second male connectors each comprise at least one bolt protruding from the support arm to engage at least a first one of at the least two bolt holes when the blade assembly is in the clockwise rotation configuration with at least a second one of the at least two bolt holes unengaged, and to engage at least the second one of the at least two bolt holes when the blade assembly is in the counter-clockwise rotation configuration with at least the first one of the at least two bolt holes unengaged.

5. The apparatus as claimed in claim 1, wherein the upper and lower female connectors each comprise a cavity that extends radially into the respective upper and lower center plates, and the first and second male connectors each comprise a protrusion protruding longitudinally outwards from the drive shaft connecting end of the respective first and second support arms.

6. The An apparatus as claimed in claim 1, wherein the upper and lower center plate components each further comprise a connecting arm extending radially outwards from the respective upper or lower center plate and the upper and lower female connectors each comprise at least two holes extending into the connecting arm, and wherein the first and second male connectors each comprise at least one dowel protruding from the respective first or second support arm to engage one of the at least two holes, and at least one bolt protruding from the support arm to engage another of the at least two holes.

7.-8. (canceled)

9. The An apparatus as claimed in claim 1, wherein the blade comprises first and second support arm connecting ends that connect respectively to an inner surface of the first and second support arms, and wherein each of the first and second support arm connecting ends has a curvature that respectively matches a curvature of the inner surface of the first and second support arms such that the inner surfaces of the first and second support arms mate flushly with the first and second support arm connecting ends.

10. A vertical axis hydrokinetic turbine apparatus, comprising:
a drive shaft assembly comprising a rotatable drive shaft, an upper center plate fixedly mounted to an upper end of the drive shaft, and a lower center plate fixedly mounted to a lower end of the drive shaft;
at least two blade assemblies, each blade assembly comprising:
a main blade having a longitudinally elongated body with a foil profile configured to produce lift in the presence of flowing water; and
first and second support arms each having a longitudinally elongated body extending away from the main blade and terminating at a drive shaft connecting end, wherein a vertical spacing of the two draft shaft connecting ends correspond to a vertical spacing of the upper and lower center plates, wherein the first and second support arms have the same foil profile as the main blade; and
at least two pairs of support arm connection interfaces, each pair for releasably connecting one of the blade assemblies to the drive shaft assembly and comprising an upper center plate component on the upper center plate, a lower center plate component on the lower center plate, and support arm components on each of the first and second support arms, wherein each of upper and lower center plate components are configured to releasably connect to either of the support arm components, thereby enabling the blade assembly to be mounted to the drive shaft assembly in a clockwise rotation configuration wherein a leading edge of the main blade faces a clockwise rotation direction of the drive shaft, and in a counter-clockwise rotation configuration wherein the blade assembly is inverted 180° to the clockwise rotation configuration and wherein the leading edge of the main blade faces a counter-clockwise rotation direction of the drive shaft;
wherein each support arm is connected at a blade connecting end to an inner surface of the main blade, and wherein each blade connecting end has a curvature that matches a curvature of the inner surface of the main blade such that the inner surface of the main blade mates flushly with the blade connecting ends; and
wherein each blade assembly comprises a first and a second corner joint, wherein each corner joint comprises at least one set of bores extending through the thickness of the main blade and into the blade connecting end of the first or second support arm, and a bolt for extending through each of the set of bores and connecting to the first or second support arm.

11. A vertical axis hydrokinetic turbine apparatus, comprising:
a drive shaft assembly comprising a rotatable drive shaft, an upper center plate fixedly mounted to an upper end of the drive shaft, and a lower center plate fixedly mounted to a lower end of the drive shaft;
at least two blade assemblies, each blade assembly comprising:
a main blade having a longitudinally elongated body with a foil profile configured to produce lift in the presence of flowing water; and
first and second support arms each having a longitudinally elongated body extending away from the main blade and terminating at a drive shaft connecting end, wherein a vertical spacing of the two draft shaft connecting ends correspond to a vertical spacing of the upper and lower center plates, wherein the first and second support arms have the same foil profile as the main blade; and
at least two pairs of support arm connection interfaces, each pair for releasably connecting one of the blade assemblies to the drive shaft assembly and comprising an upper center plate component on the upper center plate, a lower center plate component on the lower center plate, and support arm components on each of the first and second support arms, wherein each of upper and lower center plate components are configured to releasably connect to either of the support arm components, thereby enabling the blade assembly to be mounted to the drive shaft assembly in a clockwise rotation configuration wherein a leading edge of the main blade faces a clockwise rotation direction of the drive shaft, and in a counter-clockwise rotation configuration wherein the blade assembly is inverted 180° to the clockwise rotation configuration and wherein the leading edge of the main blade faces a counter-clockwise rotation direction of the drive shaft;
wherein each support arm is connected at a blade connecting end to an inner surface of the main blade, and wherein each blade connecting end has a curvature that matches a curvature of the inner surface of the main blade such that the inner surface of the main blade mates flushly with the blade connecting ends; and
wherein each blade assembly comprises a first and a second corner joint, wherein each corner joint comprises at least one protrusion extending from one of the blade connecting end and the inner surface of the main blade, and a cavity configured to receive the protrusion and located in the other of the blade connecting end and the inner surface of the main blade.

12. The apparatus as claimed in claim 1, wherein the first and second support arms and main blade of each blade assembly is integrally formed from a single component.

13. The apparatus as claimed in claim 1, wherein each blade assembly further comprises first and second curved corner joints, wherein each corner joint has a curved body with the first corner joint connected to the first support arm and one end of the main blade, and the second corner joint connected the second support arm and the other end of the main blade.

14. The apparatus as claimed in claim 1 comprising two blade assemblies and two pairs of support arm connection interfaces located circumferentially equidistant from each other about the drive shaft.

15. The apparatus as claimed in claim 1 comprising three blade assemblies and three pairs of support arm connection interfaces located circumferentially equidistant from each other about the vertical drive shaft.

16. The apparatus as claimed in claim 1, wherein for each blade assembly, the support arms are releasably coupled to the main blade.

17. A kit for a vertical axis hydrokinetic turbine apparatus, comprising:
a drive shaft assembly comprising a rotatable drive shaft, an upper center plate fixedly mountable to an upper end of the drive shaft, and a lower center plate fixedly mountable to a lower end of the drive shaft;
at least two blade assemblies, each blade assembly comprising:
a main blade having a longitudinally elongated body with a foil profile configured to produce lift in the presence of flowing water; and
first and second support arms each having a longitudinally elongated body having a blade connecting end that is connectable to the main blade and an opposite drive shaft connecting end, wherein a vertical spacing of the two draft shaft connecting ends correspond to a vertical spacing of the upper and lower center plates when the blade assembly is assembled, wherein the first and second support arms have the same foil profile as the main blade; and
at least two pairs of support arm connection interfaces, each pair for releasably connecting one of the blade assemblies to the drive shaft assembly and comprising an upper center plate component on the upper center plate comprising upper female connectors, a lower center plate component on the lower center plate comprising lower female connectors, and support arm components on each of the first and second support arms comprising a first support arm component having one or more first male connectors all collectively protruding from the first support arm at a location biased toward a leading edge of the first support arm, and a second support arm component having one or more second male connectors all collectively protruding from the second support arm at a location biased toward a leading edge of the second support arm, wherein each of the upper and lower female connectors of the upper and lower center plate components are configured to releasably connect to either of the first and second male connectors of the first and second support arm components, thereby enabling the blade assembly to be mounted to the drive shaft assembly in a clockwise rotation configuration wherein a leading edge of the main blade faces a clockwise rotation direction of the drive shaft, and in a counter-clockwise rotation configuration wherein the blade assembly is inverted 180° to the clockwise rotation configuration and wherein the leading edge of the main blade faces a counter-clockwise rotation direction of the drive shaft.

18. (canceled)
